(19) United States
(12) Patent Application Publication
(10) Pub. No.: US 2016/0274644 A1
(43) Pub. Date: Sep. 22, 2016

(54) POWER-SAVNG CONTROL DEVICE, INFORMATION PROCESSING APPARATUS, POWER-SAVING CONTROL METHOD, AND COMPUTER READABLE MEDIUM

(71) Applicant: FUJI XEROX CO., LTD., Tokyo (JP)

(72) Inventors: Kei HATANO, Kanagawa (JP); Hisaji HIRAMATSU, Kanagawa (JP); Yuichi KAWATA, Kanagawa (JP); Takanori FUKUOKA, Kanagawa (JP); Tadamasa SAKAMAKI, Kanagawa (JP)

(73) Assignee: FUJI XEROX CO., LTD., Tokyo (JP)

(21) Appl. No.: 14/818,484

(22) Filed: Aug. 5, 2015

(30) Foreign Application Priority Data
Mar. 19, 2015 (JP) 2015-056710

(51) Int. Cl. G06F 1/32

(52) U.S. Cl. CPC G06F 1/3234

(57) ABSTRACT

A power-saving control device includes a setting unit and a mode controller. The setting unit sets a period during which an information processing apparatus in a power-saving mode in which more power is saved than a first mode is caused to perform an operation for receiving data from a communication line. The mode controller sets the information processing apparatus to a second mode in which the receiving operation is performed when a current time is within the set period, and sets the information processing apparatus to a third mode in which the receiving operation is stopped when the current time is outside the set period, in a case where the information processing apparatus is in the power-saving mode.

### CROSS-REFERENCE TO RELATED APPLICATIONS

This application is based on and claims priority under 35 USC 119 from Japanese Patent Application No. 2015-056710 filed Mar. 19, 2015.

### BACKGROUND

### Technical Field

The present invention relates to a power-saving control device, an information processing apparatus, a power-saving control method, and a computer readable medium.

### SUMMARY

According to an aspect of the invention, there is provided a power-saving control device including a setting unit and a mode controller. The setting unit sets a period during which an information processing apparatus in a power-saving mode in which more power is saved than a first mode is caused to perform an operation for receiving data from a communication line. The mode controller sets the information processing apparatus to a second mode in which the receiving operation is performed when a current time is within the set period, and sets the information processing apparatus to a third mode in which the receiving operation is stopped when the current time is outside the set period, in a case where the information processing apparatus is in the power-saving mode.

### BRIEF DESCRIPTION OF THE DRAWINGS

Exemplary embodiments of the present invention will be described in detail based on the following figures, wherein:

FIG. 1 is a block diagram illustrating a hardware configuration of an information processing apparatus according to a first exemplary embodiment of the present invention;

FIG. 2 is an explanatory diagram of a status of the information processing apparatus according to the first exemplary embodiment;

FIG. 3 is a status transition diagram of the information processing apparatus according to the first exemplary embodiment;

FIG. 4 is a block diagram illustrating a detailed configuration of a power-saving controller according to the first exemplary embodiment;

FIG. 5 is a flowchart illustrating a process regarding presetting performed by the power-saving controller according to the first exemplary embodiment;

FIG. 6 is a flowchart illustrating control for modes executed by the power-saving controller according to the first exemplary embodiment;

FIG. 7 is a flowchart illustrating control for modes executed by the power-saving controller according to the first exemplary embodiment;

FIG. 8 is an explanatory diagram of a status of an information processing apparatus according to a second exemplary embodiment of the present invention; and

FIG. 9 is a flowchart illustrating control for modes executed by a power-saving controller according to the second exemplary embodiment.

### DETAILED DESCRIPTION

An information processing apparatus according to an exemplary embodiment of the present invention has a function for implementing a power-saving status in multiple stages. Hereinafter, a case will be described in which an information processing apparatus according to an exemplary embodiment of the present invention is applied to an image forming apparatus which forms an image on a medium such as paper.

### First Exemplary Embodiment

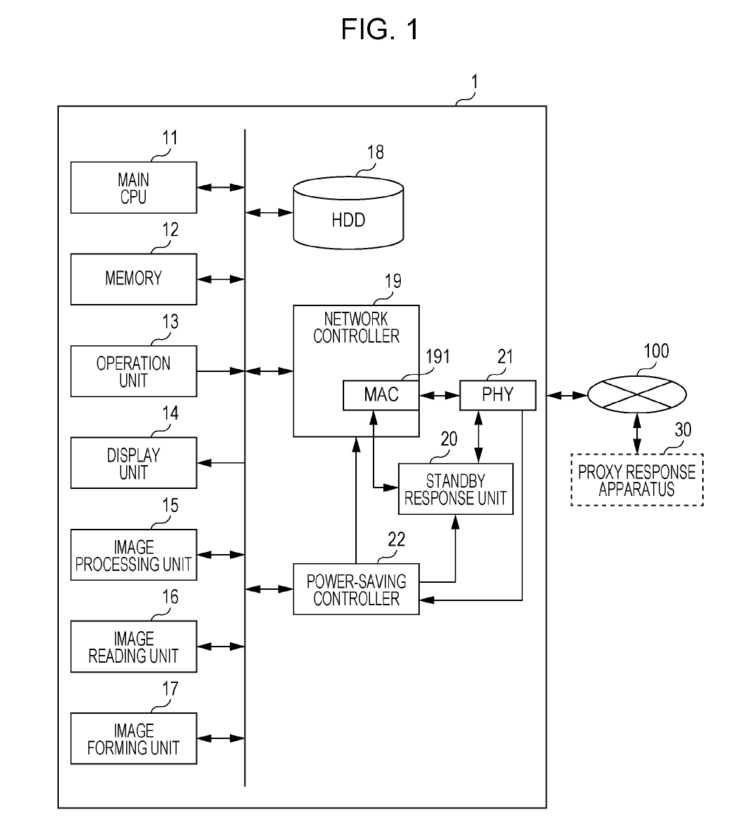

FIG. 1 is a block diagram illustrating a hardware configuration of an information processing apparatus 1 according to a first exemplary embodiment of the present invention. As illustrated in FIG. 1, the information processing apparatus 1 includes a main central processing unit (CPU) 11, a memory 12, an operation unit 13, a display unit 14, an image processing unit 15, an image reading unit 16, an image forming unit 17, a hard disk drive (HDD) 18, a network controller 19, a standby response unit 20, a physical layer (PHY) 21, and a power-saving controller 22.

A “proxy response apparatus 30” illustrated in FIG. 1 is an apparatus according to a second exemplary embodiment, which will be described later, and is not related to the first exemplary embodiment.

The main CPU 11 is an arithmetic processing device that performs arithmetic processing for controlling individual units of the information processing apparatus 1. The main CPU 11 controls the information processing apparatus 1 by developing a program stored in the HDD 18 onto the memory 12 to execute the program and reading or writing data to or from the memory 12. The memory 12 is a volatile semiconductor memory in the first exemplary embodiment and is used as a work area for the main CPU 11.

The operation unit 13 is an operation device that includes, for example, a touch screen arranged to be superimposed on a display surface of the display unit 14 and physical keys, and is operated by a user. The operation unit 13 includes, for example, a main switch for turning on and off the power of the information processing apparatus 1 and a change-over switch for switching the operation mode of the information processing apparatus 1. The information processing apparatus 1 supports a normal mode which implements an operation in a normal status, and multiple power-saving modes in which more power is saved than the normal mode. These modes will be explained later in detail.

The display unit 14 is, for example, a liquid crystal display, and informs a user of information by displaying various images (screens) on the display screen, on which images are to be displayed. The image processing unit 15 is, for example, an application specific integrated circuit (ASIC), and performs various types of image processing based on image data. The image reading unit 16 is, for example, a scanner, and reads an image of an original to generate image data representing the read image. The image forming unit 17 is a printer that forms an image based on image data on a medium by, for example, an electrophotographic process. The HDD 18 is a nonvolatile storage device that stores a program including system software executed by the main CPU 11 and other data.

The network controller 19 is a communication control device that controls communication with a communication line 100 which is performed via the PHY 21. The PHY 21 manages the processing of a physical layer of an open systems interconnection (OSI) reference model. The network controller 19 includes a media access controller (MAC) 191. The MAC 191 is a media access controller that manages processing regarding a sublayer below a data link layer of the OSI reference model. The MAC 191 is an example of a second reception unit of an exemplary embodiment of the present invention.

In the first exemplary embodiment, the communication line 100 is a local area network (LAN) that performs communication conforming to the standards of Ethernet®. For example, the communication line 100 performs communication based on various protocols such as a transmission control protocol/internet protocol (TCP/IP) and a user datagram protocol/internet protocol (UDP/IP).

The standby response unit 20 is a communication circuit, such as, for example, a large scale integration (LSI), which waits for data (that is, a packet) from the communication line 100 when the information processing apparatus 1 is in the power-saving mode. The standby response unit 20 is an example of a reception unit according to an exemplary embodiment of the present invention. In the first exemplary embodiment, the standby response unit 20 operates with a less power consumption that that of the MAC 191. Upon receiving a specific packet, the standby response unit 20 performs response processing in association with the packet. For example, upon receiving an address resolution protocol (ARP) request packet addressed to the information processing apparatus 1, the standby response unit 20 transmits an ARP response packet for sending a physical address (MAC address) of the information processing apparatus 1 as a response to the communication line 100.

The power-saving controller 22 is a control device, such as, for example, a complex programmable logic device (CPLD), and controls each unit of the information processing apparatus 1 when the information processing apparatus 1 is in the power-saving mode. The power-saving controller 22 has a timer function. The power-saving controller 22 is an example of a power-saving control device according to an exemplary embodiment of the present invention. The power-saving controller 22 controls the presence or absence of an operation of each unit of the information processing apparatus 1 and controls power supply (electric power) to each unit. The power-saving controller 22 has a power management function and performs control in association with the mode of the information processing apparatus 1.

Operation clocks are also supplied, by a clock supply circuit, which is not illustrated in FIG. 1, to hardware to which power is supplied under the control of the power-saving controller 22.

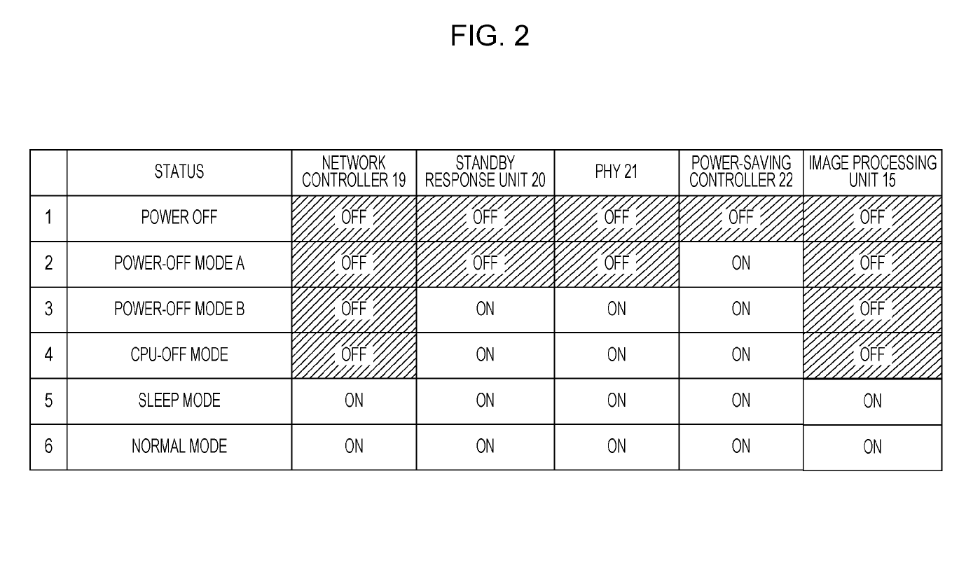

FIG. 2 is a diagram for explaining modes of the information processing apparatus 1. In FIG. 2, the status of hardware of each of the network controller 19, the standby response unit 20, the PHY 21, the power-saving controller 22, and the image processing unit 15 is illustrated for each status of the information processing apparatus 1. “On” represents the state in which power is supplied to hardware and the hardware is operated. “Off” represents the state in which power supply to hardware is stopped or reduced and all or part of the operation of the hardware is stopped. Each of the numbers in the left-end column of the table of FIG. 2 indicates the order of a mode when modes of the information processing apparatus 1 are arranged in ascending order of power consumption of the information processing apparatus 1.

As illustrated in FIG. 2, as the status of the information processing apparatus 1, “power-off” in which the power is disconnected, a “normal mode”, and a “power-off mode A”, a “power-off mode B”, a “CPU-off mode”, and a “sleep mode” that are power-saving modes in which more power is saved than the normal mode. Among the above modes, the “power-off mode A” and the “power-off mode B” will be collectively referred to as a “power-off mode” when these modes are not distinguished from each other.

The “power off” represents the status in which the entire hardware of the information processing apparatus 1 explained with reference to FIG. 1 is turned off.

The “normal mode” is an example of a first mode according to an exemplary embodiment of the present invention. In the “normal mode”, the entire hardware of the information processing apparatus 1 explained with reference to FIG. 1 is turned on. In the normal mode, the MAC 191 performs an operation for receiving a packet from the communication line 100. Therefore, in the case of the normal mode, the standby response unit 20 does not receive a packet that has arrived from the communication line 100.

The “power-off mode A” is an example of a third mode according to an exemplary embodiment of the present invention. In the “power-off mode A”, the power-saving controller 22 is turned on, and the other hardware is turned off. In the case of the power-off mode A, the PHY 21 is turned off, and neither the MAC 191 nor the standby response unit 20 performs an operation for receiving a packet. Therefore, even if a packet addressed to the information processing apparatus 1 arrives, the information processing apparatus 1 does not receive the packet.

The “power-off mode B” is an example of a second mode according to an exemplary embodiment of the present invention. In the “power-off mode B”, the standby response unit 20, the PHY 21, and the power-saving controller 22 are turned on, and the other hardware is turned off. In the case of the power-off mode B, the standby response unit 20 performs an operation for receiving a packet. In the power-off mode B, the standby response unit 20 performs filtering processing for receiving only an ARP request packet, an activation request packet (for example, a magic packet), and a specific packet according to a predetermined protocol (for example, a TCP or a UDP) and disposing of the other packets. The activation request packet is a packet for requesting for activation of the apparatus (that is, remote-on) based on a Wake On LAN function. The magic packet includes data in which the physical address of an apparatus to be activated is repeated 16 times. In the case of the power-off mode B, more power is consumed at the information processing apparatus 1 than the case of the power-off mode A by the amount of operation of the standby response unit 20 and the PHY 21. However, less power is consumed at the information processing apparatus 1 than the case in which the MAC 191 is operated instead of the standby response unit 20.

The “CPU-off mode” is a mode in which the standby response unit 20, the PHY 21, and the power-saving controller 22 are turned on, the memory 12 is in a self-refresh status, and the other hardware is turned off. In the case of the CPU-off mode, the standby response unit 20 receives a larger number of types of packet than the case of the power-off mode B. These packets include a packet for instructing the information processing apparatus 1 to perform processing.

The “sleep mode” is a mode in which the network controller 19, the standby response unit 20, the PHY 21, and the power-saving controller 22 are turned on, and the other hardware is turned off. In the case of the sleep mode, the MAC 191 performs an operation for receiving a packet from the communication line 100.

The power consumption at the information processing apparatus 1 has the following relationship among the above six statuses: power-off<power-off mode A<power-off mode B<CPU-off mode<sleep mode<normal mode.

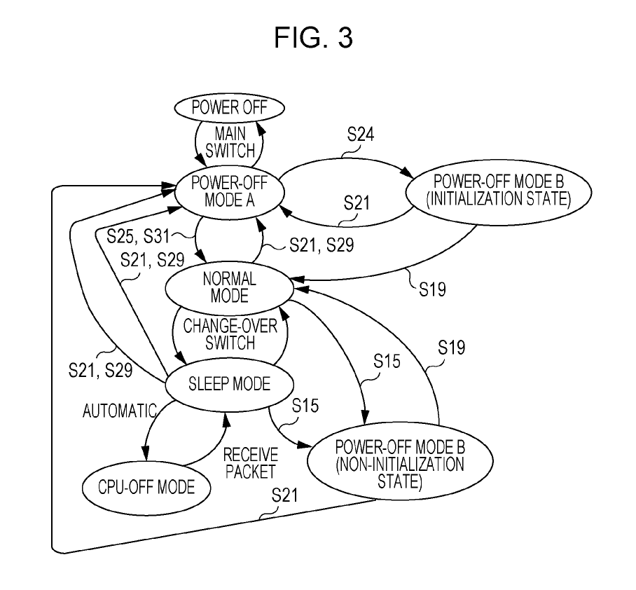

FIG. 3 is a status transition diagram of the information processing apparatus 1.

As illustrated in FIG. 3, the transition between the “power-off” and the “power-off mode A” is triggered by turning on and off of a main switch of the operation unit 13. The transition between the “normal mode” and the “sleep mode” is triggered by turning on and off of a change-over switch of the operation unit 13 or the fact that the information processing apparatus 1 has not been used for a predetermined period of time. The transition from the “sleep mode” to the “CPU-off mode” is triggered by the fact that the information processing apparatus 1 has not been used for a predetermined period of time. Conditions for such non-use include, for example, the state in which specific processing associated with reception of a packet from the communication line 100 has not been performed. The transition from the “CPU-off mode” to the “sleep mode” is triggered by reception of a specific packet (for example, a packet for issuing an instruction for execution of processing) by the standby response unit 20.

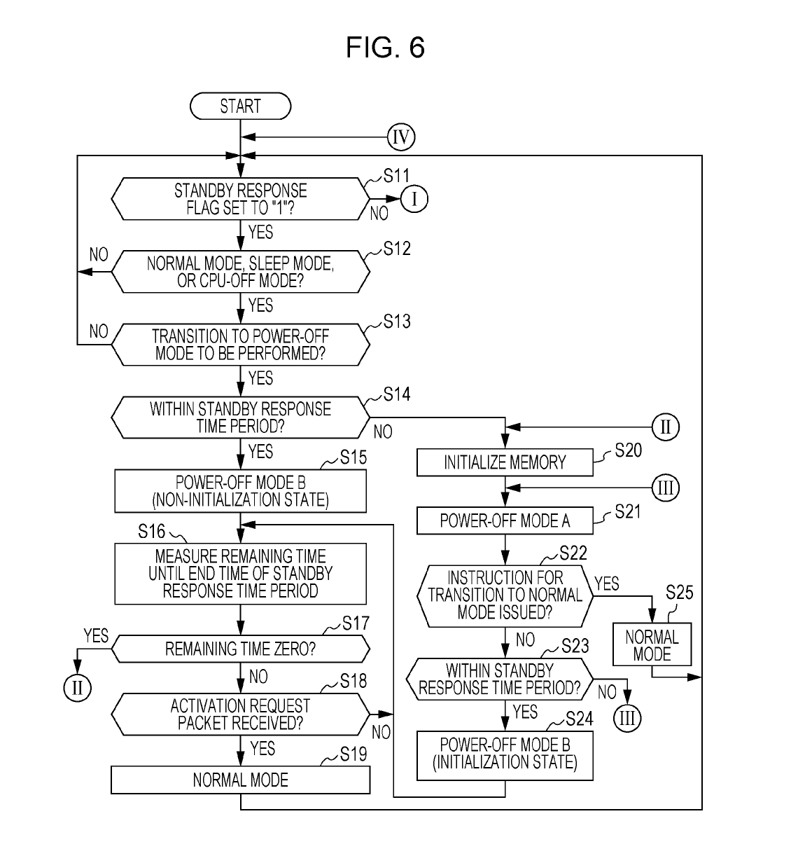

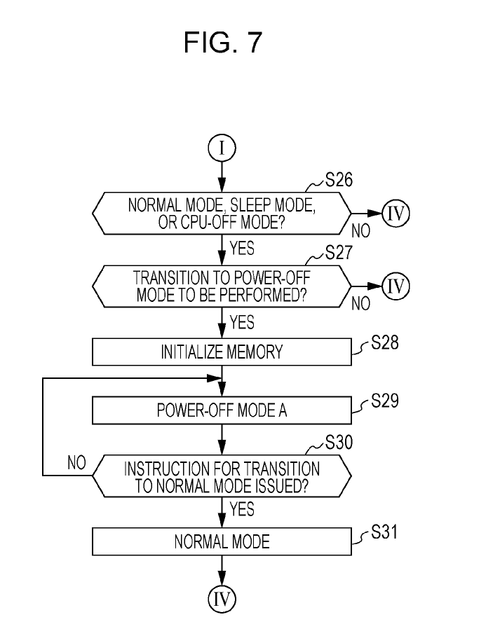

Control for the transition between modes regarding the “power-off mode A” or the “power-off mode B” is performed by the power-saving controller 22. A sign “S#” (# represents a number) illustrated in FIG. 3 corresponds to a sign of a processing step in the flowchart of FIG. 6 or FIG. 7 which will be explained later.

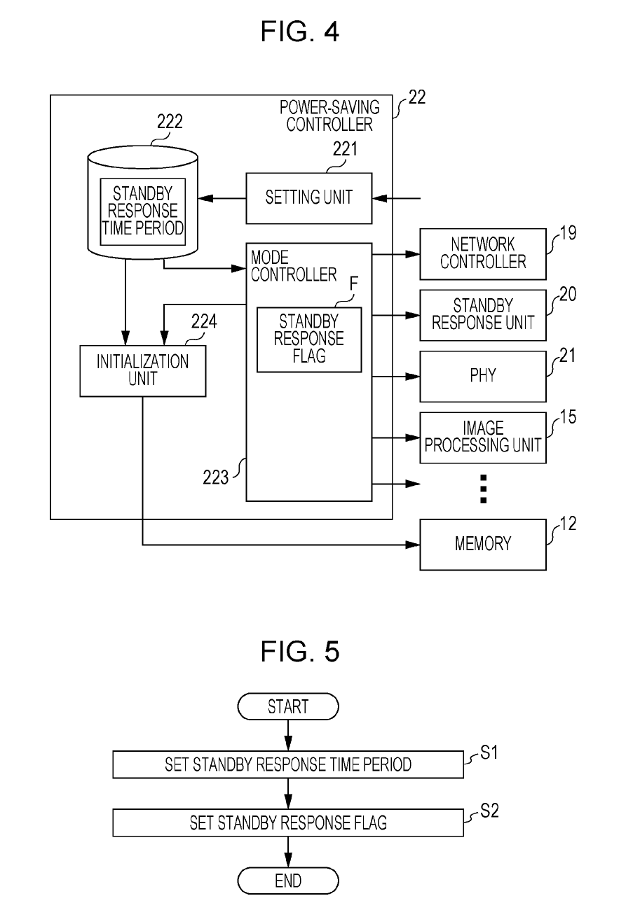

FIG. 4 is a block diagram illustrating a detailed configuration of the power-saving controller 22. As illustrated in FIG. 4, the power-saving controller 22 includes a setting unit 221, a period information storing unit 222, a mode controller 223, and an initialization unit 224.

The setting unit 221 sets a period during which the information processing apparatus 1 in the power-saving mode is caused to perform an operation for receiving a packet. In the first exemplary embodiment, this period is a condition regarding a time period for performing an operation for receiving a packet in the power-off mode, and will be referred to as a “standby response time period”. In other words, the standby response time period represents a time period during which an activation request by an activation request packet is received. The period information storing unit 222 stores information of the standby response time period set by the setting unit 221.

When the information processing apparatus 1 is in a power-saving mode, the mode controller 223 controls the mode of the information processing apparatus 1, based on the period information storing unit 222. Specifically, the mode controller 223 sets the information processing apparatus 1 to the power-off mode B when the current time is within the set standby response time period, and sets the information processing apparatus 1 to the power-off mode A when the current time is outside the set standby response time period. Furthermore, when an activation request packet is received by the standby response unit 20 in the power-off mode B, the mode controller 223 allows the information processing apparatus 1 to be shifted from the power-off mode B to the normal mode.

Furthermore, in transition from the normal mode, the sleep mode, or the CPU-off mode to a power-off mode, the mode controller 223 allows transition to the power-off mode B when the current time is within the standby response time period, and allows transition to the power-off mode A when the current time is outside the standby response time period. For the transition to the power-off mode B, the initialization unit 224 does not initialize the memory 12. In contrast, for the transition to the power-off mode A, the initialization unit 224 performs control for initializing the memory 12.

The mode controller 223 includes a register (an example of a storing unit according to an exemplary embodiment of the present invention) that stores a standby response flag F as an identifier associated with a designation by a user. In the case where the standby response time period has been reached in the power-off mode A, when “1” (first identifier) is stored as the standby response flag F, the mode controller 223 allows transition from the power-off mode A to the power-off mode B, and when “0” (second identifier) is stored as the standby response flag F, the mode controller 223 maintains the power-off mode A.

FIG. 5 is a flowchart illustrating a process regarding presetting performed by the information processing apparatus 1.

First, the power-saving controller 22 sets a standby response time period (step S1). The power-saving controller 22 sets the standby response time period associated with an operation of the operation unit 13. A user performs, for example, an operation for setting a start time and an end time of the standby response time period. For example, the standby response time period is not a time period during which the user uses the information processing apparatus 1 but a time period during which external data is expected to be received. This time period is, for example, a time period during which data is assumed to be received from a foreign county in a different time zone.

Next, the power-saving controller 22 sets the standby response flag F (step S2). The power-saving controller 22 sets, for example, the standby response flag F in association with an operation of the operation unit 13.

FIGS. 6 and 7 are flowcharts illustrating control for modes executed by the power-saving controller 22.

First, the power-saving controller 22 determines whether or not the standby response flag F is “1” (step S11). When the determination result in step S11 is “YES”, the power-saving controller 22 determines whether or not the mode of the information processing apparatus 1 is one of the normal mode, the sleep mode, and the CPU-off mode (step S12). When the determination result in step S12 is “YES”, the power-saving controller 22 determines whether or not to perform transition to the power-off mode (step S13). When the determination result in step S12 or S13 is “NO”, the power-saving controller 22 returns to the processing of step S11. In the case of the normal mode, the sleep mode, or the CPU-off mode, the program developed on the memory 12 by the main CPU 11 remains in the developed state. For example, when the change-over switch of the operation unit 13 is turned off, the power-saving controller 22 obtains the determination result “YES” in step S13. However, conditions for transition to the power-off mode are not limited to this.

When the determination result in step S13 is “YES”, the power-saving controller 22 determines whether or not the current time is within the standby response time period (step S14). It is assumed that the standby response time period is set to a period of time from “6:00 am until 9:00 am”. In this case, the power-saving controller 22 determines whether or not the current time is within the period of time from 6:00 am until 9:00 am. When the determination result in step S14 is “YES”, the power-saving controller 22 allows transition from the current mode to the power-off mode B (step S15). In this transition, the memory 12 is not initialized, and the program is in the developed state (that is, a non-initialization state).

Next, the power-saving controller 22 measures, using a timer, the remaining time until the end time of the standby response time period (step S16). If the current time is 7:30 am, the power-saving controller 22 obtains the remaining time “one and a half hours”.

Next, the power-saving controller 22 determines whether or not the measured remaining time has reached zero (step S17). When the current time is within the standby response time period, the power-saving controller 22 obtains the determination result “NO” in step S17. Next, the power-saving controller 22 determines whether or not an activation request packet is received by the standby response unit 20 (step S18). When the determination result in step S18 is “NO”, the power-saving controller 22 returns to step S16 to continue measurement of the remaining time.

When it is determined that the activation request packet is received during the period of the power-off mode B (step S18; YES), the power-saving controller 22 allows the information processing apparatus 1 to be shifted from the power-off mode B to the normal mode (step S19). When receiving an ARP request packet addressed to the information processing apparatus 1, the standby response unit 20 transmits an ARP response packet which includes the physical address of the information processing apparatus 1 to the communication line 100. After that, when the PHY 21 receives an activation request packet which is generated using the physical address, the power-saving controller 22 allows transition to the normal mode in step S19. In this case, since the program is developed on the memory 12, a normal cold boot is unnecessary. Accordingly, processing based on the program after allowing the information processing apparatus 1 to be shifted to the normal mode again, may be promptly resumed.

When the power-saving controller 22 determines that the remaining time has reached zero in the power-off mode B (step S17; YES), the power-saving controller 22 initializes the memory 12 (step S20). Next, the power-saving controller 22 allows the information processing apparatus 1 to be shifted from the power-off mode B to the power-off mode A (step S21). In the case where the current time is outside the standby response time period, an operation of the standby response unit 20 for receiving a packet is stopped. Therefore, a higher power-saving effect of the information processing apparatus 1 may be achieved than the case where the current time is within the standby response time period.

The power-saving controller 22 determines whether or not an instruction for transition to the normal mode is issued during the period of the power-off mode A (step S22). As described above, during the period of the power-off mode A, the information processing apparatus 1 does not perform an operation for receiving a packet. Therefore, in step S22, the power-saving controller 22 determines whether or not an instruction for transition to the normal mode is issued in association with an operation of the change-over switch of the operation unit 13. When the determination result in step S22 is “YES”, the power-saving controller 22 allows the information processing apparatus 1 to be shifted from the power-off mode A to the normal mode (step S25). Then, the power-saving controller 22 returns to the processing of step S11.

When the determination result in step S22 is “NO”, the power-saving controller 22 determines whether or not the current time is within the standby response time period (step S23). This determination may be the same as the determination in step S14. When the determination result in step S23 is “NO”, the power-saving controller 22 returns to the processing of step S21, and the information processing apparatus 1 remains in the power-off mode A.

When the determination result in step S23 is “YES”, the power-saving controller 22 allows the information processing apparatus 1 to be shifted from the power-off mode A to the power-off mode B (step S24). In this case, the memory 12 is in the state of being initialized (that is, an initialization state). When the information processing apparatus 1 is shifted to the power-off mode B, the power-saving controller 22 proceeds to the processing of step S16, and measures the remaining time until the end time of the standby response time period. The subsequent operation is as explained above.

In the case where the information processing apparatus 1 is shifted from the power-off mode A to the normal mode, the memory 12 is in the initialized state. Therefore, cold boot is performed.

When it is determined that the current time is outside the standby response time period (step S14; NO), the power-saving controller 22 initializes the memory 12 (step S20) and then allows the information processing apparatus 1 to be shifted from the current mode to the power-off mode A (step S21).

When it is determined in step S11 that the standby response flag F is “0” (step S11; NO), the power-saving controller 22 proceeds to the processing of step S26 of FIG. 7. Next, the power-saving controller 22 determines whether or not the mode of the information processing apparatus 1 is one of the normal mode, the sleep mode, and the CPU-off mode (step S26). When the determination result in step S26 is “YES”, the power-saving controller 22 determines whether or not to perform transition to the power-off mode (step S27). When the determination result in step S26 or S27 is “NO”, the power-saving controller 22 returns to the processing of step S11.

When the determination result in step S27 is “YES”, the power-saving controller 22 initializes the memory 12 (step S28), and allows the information processing apparatus 1 to be shifted from the current mode to the power-off mode A (step S29). In the case where the standby response flag F is “0”, the power-saving controller 22 allows the information processing apparatus 1 to be shifted to the power-off mode A, irrespective of whether or not the current time is within the standby response time period.

Next, the power-saving controller 22 determines whether or not an instruction for transition to the normal mode is issued during the period of the power-off mode A (step S30). This determination may be the same as the determination in step S22. When the determination result in step S30 is “NO”, the power-saving controller 22 allows the information processing apparatus 1 to remain in the power-off mode A. When the determination result in step S30 is “YES”, the power-saving controller 22 allows the information processing apparatus 1 to be shifted from the power-off mode A to the normal mode (step S31). Then, the power-saving controller 22 returns to the processing of step S11.

The information processing apparatus 1 according to the first exemplary embodiment described above operates in the power-off mode B when the current time is within the standby response time period, and operates in the power-off mode A when the current time is outside the standby response time period, during the period of the power-off mode. Therefore, during a period in which it is expected that data to be received exists (within the standby response time period), the information processing apparatus 1 is able to receive the data. During the other period, the information processing apparatus 1 operates in the power-off mode A, which has a higher power-saving effect than the power-off mode B. Therefore, a higher power-saving effect may be achieved than the case where the information processing apparatus 1 constantly waits for data from the communication line 100 during the period in which the information processing apparatus 1 is in the power-saving mode.

### Second Exemplary Embodiment

In a second exemplary embodiment, the proxy response apparatus 30 illustrated in FIG. 1 is connected to the communication line 100. In place of the information processing apparatus 1, the proxy response apparatus 30 receives an ARP request packet addressed to the information processing apparatus 1, and transmits an ARP response packet for sending the physical address of the information processing apparatus 1 as a response to the communication line 100. For this response, the proxy response apparatus 30 stores beforehand the logical address (IP address) in the communication line 100 of the information processing apparatus 1 and the physical address of the information processing apparatus 1. The processing regarding an ARP is performed by the proxy response apparatus 30 as described above, and therefore the information processing apparatus 1 according to the second exemplary embodiment stops the standby response unit 20 during this period.

The hardware configuration of the information processing apparatus 1 according to the second exemplary embodiment is the same as the first exemplary embodiment described above, and an explanation for the hardware configuration of the information processing apparatus 1 according to the second exemplary embodiment will be omitted. In the second exemplary embodiment, elements referred to with the same reference signs as the first exemplary embodiment are the same as those in the first exemplary embodiment.

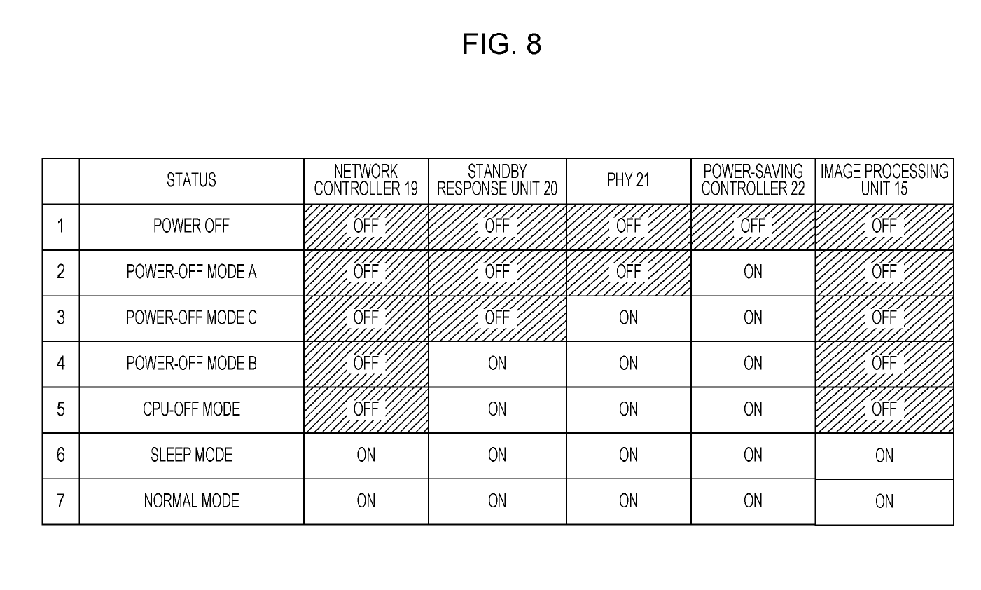

FIG. 8 is a diagram for explaining modes of the information processing apparatus 1. As illustrated in FIG. 8, the information processing apparatus 1 according to the second exemplary embodiment supports a power-off mode C, in addition to the modes explained in the first exemplary embodiment. In the second exemplary embodiment, the “power-off mode A”, the “power-off mode C”, and the “power-off mode B” are collectively referred to as a power-off mode.

The “power-off mode C” is an example of a fourth mode according to an exemplary embodiment of the present invention. In the power-off mode C, the PHY 21 and the power-saving controller 22 are turned on, and the other hardware including the standby response unit 20 is turned off. In the power-off mode C, the operation of the MAC 191 and the standby response unit 20 is stopped, and therefore more power is saved at the information processing apparatus 1 than the case of the power-off mode B. Furthermore, in the case of the power-off mode C, for example, a magic packet is received by the PHY 21, and the operation of the MAC 191 and the standby response unit 20 is stopped. Therefore, in the power-off mode C, reception of data at the information processing apparatus 1 is more restricted than the case of the power-off mode B. Restriction of data reception represents a reduction in the number of types of packets that may be received. The power consumption at the information processing apparatus 1 in the second exemplary embodiment has the following relationship among the seven statuses: power-off<power-off mode A<power-off mode C<power-off mode B<CPU-off mode<sleep mode<normal mode.

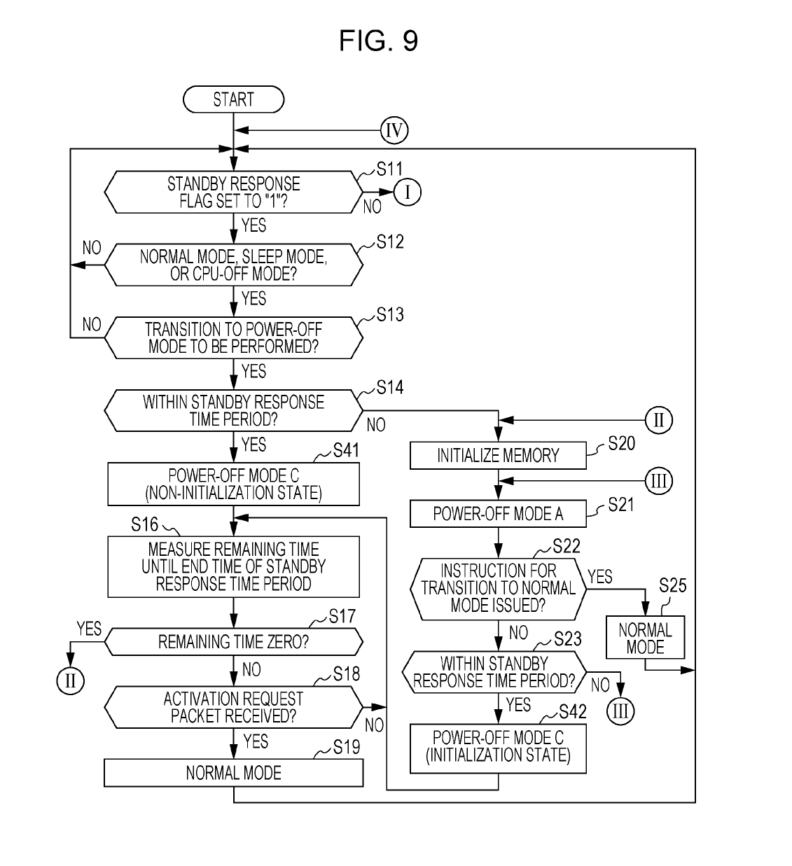

FIG. 9 is a flowchart illustrating control for modes executed by the power-saving controller 22. As illustrated in FIG. 9, in the case where the proxy response apparatus 30 exists, the power-saving controller 22 sets the mode of the information processing apparatus 1 to the power-off mode C, instead of the power-off mode B.

Specifically, when it is determined that the current time is within the standby response time period (step S14; YES) in the case where it is determined that the information processing apparatus 1 is to be shifted from the normal mode, the sleep mode, or the CPU-off mode to the power-off mode (step S12; YES→step S13; YES), the power-saving controller 22 allows the mode of the information processing apparatus 1 to be shifted from the current mode to the power-off mode C (step S41).

Next, the power-saving controller 22 measures, using a timer, the remaining time until the end time of the standby response time period (step S16). When it is determined that the measured remaining time is not zero (step S17; NO), the power-saving controller 22 determines whether or not an activation request packet is received by the standby response unit 20 (step S18). After the proxy response apparatus 30 transmits an ARP response packet, in place of the information processing apparatus 1, an activation request packet generated using the physical address of the information processing apparatus 1 arrives from the communication line 100. When the activation request packet is received by the PHY 21, the power-saving controller 22 allows the information processing apparatus 1 to be shifted from the power-off mode C to the normal mode (step S19). As described above, the information processing apparatus 1 is shifted from the power-off mode C in which the operation of the standby response unit 20 is stopped to the normal mode. In this case, the program remains being developed on the memory 12. Therefore, processing based on the corresponding program after the information processing apparatus 1 is shifted to the normal mode again is promptly resumed.

Furthermore, as in the first exemplary embodiment, after initializing the memory 12 in step S20 and allowing the mode of the information processing apparatus 1 to be shifted to the power-off mode A in step S21, the power-saving controller 22 determines whether or not an instruction for transition to the normal mode is issued in step S22. When the determination result in step S22 is “YES” and it is determined that the current time is within the standby response time period (step S23; YES), the power-saving controller 22 allows the mode of the information processing apparatus 1 to be shifted from the power-off mode A to the power-off mode C (step S42). Then, the power-saving controller 22 proceeds to the processing of step S16.

The processing steps for which explanation is omitted in the second exemplary embodiment may be the same as those in the first exemplary embodiment.

The information processing apparatus 1 according to the second exemplary embodiment performs an operation explained with reference to FIG. 9 when it is determined that the proxy response apparatus 30 exists, and performs an operation explained with reference to FIGS. 6 and 7 when it is determined that the proxy response apparatus 30 does not exist. A method for determining whether or not the proxy response apparatus 30 exists is not particularly limited. For example, the power-saving controller 22 may make a determination based on an operation of the operation unit 13 or may make a determination based on a function for searching for the proxy response apparatus 30 which is connected to the communication line 100.

The information processing apparatus 1 according to the second exemplary embodiment described above operates in the power-off mode C when the current time is within the standby response time period, and operates in the power-off mode A when the current time is outside the standby response time period, during the period of the power-off mode. With the information processing apparatus 1, power-saving effects may further be increased in association with an operation in the power-off mode C instead of the power-off mode B. Furthermore, in place of the information processing apparatus 1, the proxy response apparatus 30 performs processing regarding an ARP, and therefore control by the information processing apparatus 1 after reception of an activation request packet proceeds. In addition, the information processing apparatus 1 according to the second exemplary embodiment may achieve effects explained in the first exemplary embodiment described above.

### Modifications

Exemplary embodiments different from those explained above may also be applied to the present invention. Furthermore, modifications described below may be combined together.

The information processing apparatus 1 may support at least three modes, that is, the normal mode, the power-off mode A, and the power-off mode B. The information processing apparatus 1 does not necessarily support one or both of the CPU-off mode and the sleep mode.

Part of the configuration and the operation explained in each of the foregoing exemplary embodiments may be omitted. For example, for transition to the power-off mode B, the power-saving controller 22 may always initialize the memory 12. Furthermore, the power-saving controller 22 may not have a function for performing control in association with the standby response flag F. In this case, the power-saving controller 22 may perform control for the case where the standby response flag F is “1”, without performing control for the case where the standby response flag F is “0”.

The information processing apparatus 1 does not necessarily include the standby response unit 20. In this case, the MAC 191 may perform processing regarding an ARP in the power-off mode. Thus, in the power-off mode B, the MAC 191 is turned on so that the function of the standby response unit 20 explained in the foregoing exemplary embodiments may be implemented. Even in this case, under the control of the power-saving controller 22, when the information processing apparatus 1 is in the power-saving mode, efficient power saving may be attained, and during a period in which it is expected that the data to be received exists, the data may be received. As described above, the reception unit according to an exemplary embodiment of the present invention may be considered to be a MAC, and hardware is not particularly limited.

The power-saving controller 22 may set the period during which the information processing apparatus 1 is set to the power-off mode B, according to conditions other than a time period. For example, the power-saving controller 22 may set the period for transition to the power-off mode B, based on one or more temporal elements including a time period, a day of the week, a date, and the remaining time until a specific date and time.

A power-saving control device according to an exemplary embodiment of the present invention is not limited to a device which is integrated with an information processing apparatus but may be a device (for example, a dedicated processor) which may be attached to and removed from the information processing apparatus.

A communication line used in an exemplary embodiment of the present invention is not limited to a LAN which performs communication conforming to the standards of Ethernet. Furthermore, a communication line used in an exemplary embodiment of the present invention may be a wired communication line, a wireless communication line, or a combination of the wired and wireless communication lines.

An information processing apparatus according to an exemplary embodiment of the present invention is not necessarily an image forming apparatus which forms an image but may be any type of apparatus, such as a personal computer, which has a function for receiving data from a communication line.

Each function implemented by the power-saving controller 22 according to the foregoing exemplary embodiments may be implemented by one or multiple hardware circuits, may be implemented by executing one or multiple programs for causing a computer to implement the function, or may be implemented by the combination of the above configurations. In the case where the function of the power-saving controller 22 is implemented using a program, the program may be stored in a computer-readable recording medium, such as a magnetic recording medium (a magnetic tape, a magnetic disk (an HDD, a flexible disk (FD), etc.)), an optical recording medium (an optical disk etc.), a magneto-optical recording medium, and a semiconductor memory and supplied or may be distributed through a communication line such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A power-saving control device comprising:
a setting unit that sets a period during which an information processing apparatus in a power-saving mode in which more power is saved than a first mode is caused to perform an operation for receiving data from a communication line; and
a mode controller that sets the information processing apparatus to a second mode in which the receiving operation is performed when a current time is within the set period, and sets the information processing apparatus to a third mode in which the receiving operation is stopped when the current time is outside the set period, in a case where the information processing apparatus is in the power-saving mode.

2. The power-saving control device according to claim 1, further comprising:
an initialization unit that performs control such that a memory on which a program for controlling the information processing apparatus is developed is not initialized in a case where the information processing apparatus is shifted from the first mode to the second mode and such that the memory is initialized in a case where the information processing apparatus is shifted from the first mode to the third mode.

3. The power-saving control device according to claim 1, wherein when specific data is received by the information processing apparatus in the second mode, the mode controller allows the information processing apparatus to be shifted from the second mode to the first mode.

4. The power-saving control device according to claim 2, wherein when specific data is received by the information processing apparatus in the second mode, the mode controller allows the information processing apparatus to be shifted from the second mode to the first mode.

5. The power-saving control device according to claim 3,
wherein the specific data is data which includes a physical address of the information processing apparatus as a destination address, and
wherein when the information processing apparatus is set to the power-saving mode in a case where a response apparatus that sends the physical address as a response in place of the information processing apparatus exists, the mode controller sets the information processing apparatus to a fourth mode in which reception of the data is more restricted than the second mode and more power is saved than the second mode.

6. The power-saving control device according to claim 4,
wherein the specific data is data which includes a physical address of the information processing apparatus as a destination address, and
wherein when the information processing apparatus is set to the power-saving mode in a case where a response apparatus that sends the physical address as a response in place of the information processing apparatus exists, the mode controller sets the information processing apparatus to a fourth mode in which reception of the data is more restricted than the second mode and more power is saved than the second mode.

7. The power-saving control device according to claim 1, further comprising:
a storing unit that stores an identifier associated with a designation by a user,
wherein in a case where the period has been reached in the third mode, the mode controller allows the information processing apparatus to be shifted from the third mode to the second mode when a first identifier is stored in the storing unit, and allows the information processing apparatus to remain in the third mode when a second identifier is stored in the storing unit.

8. The power-saving control device according to claim 2, further comprising:
a storing unit that stores an identifier associated with a designation by a user,
wherein in a case where the period has been reached in the third mode, the mode controller allows the information processing apparatus to be shifted from the third mode to the second mode when a first identifier is stored in the storing unit, and allows the information processing apparatus to remain in the third mode when a second identifier is stored in the storing unit.

9. The power-saving control device according to claim 3, further comprising:
a storing unit that stores an identifier associated with a designation by a user,
wherein in a case where the period has been reached in the third mode, the mode controller allows the information processing apparatus to be shifted from the third mode to the second mode when a first identifier is stored in the storing unit, and allows the information processing apparatus to remain in the third mode when a second identifier is stored in the storing unit.

10. The power-saving control device according to claim 4, further comprising:
a storing unit that stores an identifier associated with a designation by a user,
wherein in a case where the period has been reached in the third mode, the mode controller allows the information processing apparatus to be shifted from the third mode to the second mode when a first identifier is stored in the storing unit, and allows the information processing apparatus to remain in the third mode when a second identifier is stored in the storing unit.

11. The power-saving control device according to claim 5, further comprising:
a storing unit that stores an identifier associated with a designation by a user,
wherein in a case where the period has been reached in the third mode, the mode controller allows the information processing apparatus to be shifted from the third mode to the second mode when a first identifier is stored in the storing unit, and allows the information processing apparatus to remain in the third mode when a second identifier is stored in the storing unit.

12. The power-saving control device according to claim 6, further comprising:
a storing unit that stores an identifier associated with a designation by a user,
wherein in a case where the period has been reached in the third mode, the mode controller allows the information processing apparatus to be shifted from the third mode to the second mode when a first identifier is stored in the storing unit, and allows the information processing apparatus to remain in the third mode when a second identifier is stored in the storing unit.

13. An information processing apparatus comprising:
a reception unit that receives data from a communication line;
a setting unit that sets a period during which the reception unit is caused to perform an operation for receiving data when the information processing apparatus is in a power-saving mode in which more power is saved than a first mode; and
a mode controller that sets the information processing apparatus to a second mode in which the receiving operation is performed when a current time is within the set period, and sets the information processing apparatus to a third mode in which the receiving operation is stopped when the current time is outside the set period, in the power-saving mode.

14. The information processing apparatus according to claim 13, wherein the reception unit is different from a second reception unit that receives data from the communication line in the first mode.

15. A power-saving control method comprising:
setting a period during which an information processing apparatus in a power-saving mode in which more power is saved than a first mode is caused to perform an operation for receiving data from a communication line; and
setting the information processing apparatus to a second mode in which the receiving operation is performed when a current time is within the set period, and setting the information processing apparatus to a third mode in which the receiving operation is stopped when the current time is outside the set period, in a case where the information processing apparatus is in the power-saving mode.

16. A non-transitory computer readable medium storing a program causing a computer to execute a process for power- saving control, the process comprising:
setting a period during which an information processing apparatus in a power-saving mode in which more power is saved than a first mode is caused to perform an operation for receiving data from a communication line; and
setting the information processing apparatus to a second mode in which the receiving operation is performed when a current time is within the set period, and setting the information processing apparatus to a third mode in which the receiving operation is stopped when the current time is outside the set period, in a case where the information processing apparatus is in the power-saving mode.
